(19) United States
(12) Patent Application Publication
(10) Pub. No.: US 2021/0082379 A1
(43) Pub. Date: Mar. 18, 2021

(54) SYSTEMS FOR SECURING MUSICAL INSTRUMENTS INSIDE MUSICAL INSTRUMENT CASES

(71) Applicant: Nathan Owen Brown, Seattle, WA (US)

(72) Inventor: Nathan Owen Brown, Seattle, WA (US)

(21) Appl. No.: 17/019,309

(22) Filed: Sep. 13, 2020

Related U.S. Application Data
(60) Provisional application No. 62/900,224, filed on Sep. 13, 2019.

(51) Int. Cl. G10G 7/00; G10G 5/00

(52) U.S. Cl. CPC G10G 7/005; G10G 5/00

(57) ABSTRACT

This disclosure is directed to systems for stabilizing and protecting musical instruments inside their instrument cases. The systems include mechanically adjustable end pieces that are able to secure a wide variety of musical instruments within musical instrument cases.

### CROSS-REFERENCE TO RELATED APPLICATION

This application claims the benefit of Provisional Application 62/900,224, filed Sep. 13, 2019.

### TECHNICAL FIELD

The present disclosure generally relates to the field of musical instruments, and in particular, to securely storing musical instruments inside musical instrument cases.

### BACKGROUND

Musical instruments are often expensive, delicate, and costly to repair. Musicians often use specialized devices to protect their instruments including instrument cases and protective end pieces. For example, it is common for saxophone players around the world to store the saxophone in the case with an end piece, often referred to as an end plug or end cap, that fits between the top of their saxophone body end neck socket and the inner wall of the case. The end piece braces the small octave key arm that extends beyond the end of the body tube so the octave key is less likely to bend or break off during storage and transport in a loose fitting case. Other common examples of end pieces include tenon caps for oboe, clarinet, flute and so forth. One function of end pieces is to protect high-tolerance connections of the musical instrument body tube. For example, a clarinet tenon cap is used to protect the upper joint tenon that must keep its shape to properly form an airtight seal in the mortis of the lower joint. Clarinet tenons are also thinner body material that can damage more easily than thicker body materials elsewhere. So using a tenon cap provides added protection. Another function of end pieces is to protect delicate key mechanisms such as the saxophone octave key arm described previously that extends past the end of the saxophone body tube and interacts with the neck octave key when the saxophone is fully assembled.

End pieces are commonly made of rigid material such as metal, wood, or plastic. Manufacturers tend to design end pieces for a specific model of musical instrument or create generic end piece designs to fit most instruments and cases but not all. The size and fit quality of generic end pieces can vary wildly and often frustrates musicians struggling with end pieces that are either too big or too small to fit their instrument or instrument case. This can result in the end pieces shifting position during transport and inadequate instrument protection inside loose cases.

Professional musicians facing this problem sometimes pay for custom-made end pieces to match their musical instrument and case. However, musical instrument cases degrade over time and need replacing or the musicians may choose another model of instrument or case which can cause custom end pieces to no longer work well.

End pieces made of rigid materials also have negative consequences. For example, when an instrument case receives impact from a drop or hit, the impact force travels through the case into the rigid end piece and directly into the musical instrument. This can lead to significant and costly damage to the instrument or instrument case.

Instrument cases are another important protection for musical instruments. If a musical instrument is not secured well inside of its instrument case, the instrument can shift during transport causing damage to the instrument or the case itself. Woodwind and brasswind instruments are often made of delicate or precious materials. For example, silver flutes, rare wood oboes, or gold-plated trumpets. Ill-fitting instrument cases that do hold the instrument stable may cause expensive damage to the instrument. Some examples of this include an oboe tenon crack or a saxophone body tube bend when a player drops the case on the ground. Though a small crack in an oboe or slight bent saxophone body may appear minor to the untrained eye it can cause serious malfunction, requiring major disassembly, specialized tools to fix the body, and costly repair expertise to conduct the procedure. Also, when an instrument case is loose fitting the repeated sliding of the instrument across the case padding can cause tears and degrade the case padding integrity such that the case needs to be replaced. The friction of a sliding instrument inside the case can also wear on the instrument's finish or mechanism over time.

Manufacturing a one-size-fits-all case for a given musical instrument is challenging because instrument makers vary their designs and dimensions between model years or styles.

High quality musical instrument cases manufacturers attempt to mitigate this concern with plush padding and special contours designed to brace the instrument evenly and absorb impact. For example, a case with plush padding may accept a vintage 1930s saxophone with large reverse bell key guards if the musician presses the saxophone down into the padding hard enough for several days. This allows the plush padding to deform to the shape of the saxophone. The negative effect of this approach is that the highly compressive padding is prone to over-compression resulting in a loose-fitting case. This also means the specifically compressed padding may no longer function well to hold modern saxophone contours.

High quality cases costing several hundred dollars may still not provide a solid fit for the varied shapes of the many different makes and models of musical instruments. Additionally, all musical instrument cases degrade over time as padding material fatigues and case structure fails due to regular use such as is common with a touring musician. Some musicians are emotionally attached to the cases they have traveled extensively with and choose not to replace the case even when the case no longer protects the instrument inside.

Custom made musical instrument cases are another way many musicians approach the problem. Custom built for a specific make or model of musical instrument, these cases can cost $1000 or more. This approach is high cost to the musician and provides a narrow use application rather than providing a case to protect many different makes and models of the instrument.

Even when there is no major impact or trauma to a musical instrument case, if the case does not hold the musical instrument safely inside it, the instrument may be damaged. For example, backpack straps have become a popular feature on musical instrument cases. But when a player swings a case over their shoulder onto their back, a loose-fitting case allows the musical instrument to shift violently. Plus, backpack cases are jostled with greater rotation and distance from ground level to shoulder height.

The concern of a good fitting case is further complicated by heavier instruments with delicate key work or thin or fragile body material. When such instruments receive case impact they can be damaged under the shifting of their own weight. Two examples include a multi-pieced wood bassoon with numerous delicate key mechanisms, or a large baritone saxophone with thin metal body tubes. Either of these instruments can be damaged under their own weight shifting in a loose case.

Case makers have also tried leather or cloth straps with buckles to secure the instrument inside generically-sized musical instrument cases. This simpler approach attempted to serve instruments while decreasing case manufacturing cost. But the practice was abandoned because it proved cumbersome for players and caused scratches to the instrument finish. Today, some case makers still use straps to secure instruments inside the case. This is still undesirable because instrument finishes can be affected by the friction from such straps.

### SUMMARY

The present disclosure describes support systems for stabilizing and protecting musical instruments inside their instrument cases, thereby reducing damage to the musical instrument and damage to the interior of the musical instrument case when the case is jostled or receives a forceful impact. The system includes end pieces, mechanically adjustable end pieces, and various embodiments for combining one or more of such devices to quickly and affordably secure a wide variety of musical instruments within musical instrument cases.

It should be noted that although various systems are described below with reference to securing a saxophone within a saxophone instrument case, the systems may be configured, scaled, and used to secure any musical instrument within an associated musical instrument case.

### DESCRIPTION OF THE DRAWINGS

FIG. 1 shows a flow diagram of an example support system for securely holding a musical instrument in an instrument case.

FIG. 2 shows an exploded view of an example support system for securely holding a musical instrument in an instrument case.

FIG. 3 shows a section view close up of an example support system inserted in a body tube end of an instrument and with the support system interacting against the interior of an instrument case.

FIG. 4A shows the top view of the end piece shown in FIG. 2 and FIG. 3.

FIG. 4B shows the top view of another embodiment of an end piece from this system, in this embodiment having multiple springs.

FIG. 5 shows an exploded view of an example support system for securely holding a musical instrument in a case. In this example the system is shown interacting with an oboe tenon body end.

### DETAILED DESCRIPTION

Various terms used in the present disclosure are described as follows, although such terms may have other descriptions included in the present disclosure or may otherwise be described in the art. Terms not listed here may also have meanings described in the present disclosure or may otherwise be described in the art.

“Musical Instrument,” “wind instrument,” or “instrument” refers to any portable woodwind or brasswind instrument.

“Case” refers to any protective container intended for portable or stationary storage of a musical instrument.

“Body” or “body tube” refers to any part of a musical instrument used for the generation of sound, or the surface along which, or through which, the sound resonates and/or travels. The body includes the structure through which the forced air and/or sound vibrations flow. The body may include, for example, the mouthpiece, the neck, the body tube, the valves, the vents, the bell, the bow, the tenon, etc. For example, if the musical instrument is a saxophone, the body of the instrument includes the reed, mouthpiece, neck, body tube, vents, bow and bell.

“Body End” or “body tube end” refers to the beginning or end of a musical instrument body tube section. For example, a standard saxophone body starting at the neck and ending at the bell would have four body ends namely the first opening of the neck, second opening of the neck, first opening of the main body tube, and final opening of the main body tube commonly referred to as a bell ring. A standard oboe body without reed has six body ends including the first opening of the upper joint, second opening of the upper joint, first opening of the lower joint, second opening of the lower joint, first opening of the bell piece and final opening of the bell piece.

“End Piece” refers to a device separate from the musical instrument that interacts with a musical instrument body end. This includes, but is not limited to, a plug, cap, end cap, end plug, tenon cap, mute, bell clips, clamps or fasteners to the body, or devices that interact with a mortis, tenon, socket, or bell of the body, etc.

“Mechanically Adjustable” refers to the ability of mechanically changing the external physical dimensions of an device within a musical instrument case cavity via adjustable parts. Recitation of “Mechanical Adjustability” refers to “Mechanically Adjustable”.

“Key Mechanism” refers to all other pieces that form part of the musical instrument, aside from the body. Key mechanisms generally couple the key touches to the key cups to facilitate the opening and/or closing of pads over vents, but supporting and ancillary devices are also included in the definition of key mechanism. For example, if the musical instrument is a saxophone, the key mechanism would include all ribs, posts, rods, arms, key touches, key tabs, springs, key cups, bumpers, guards, feet, levers, auxiliary levers, thumb rests, thumb hooks, or a lyre holder, etc.

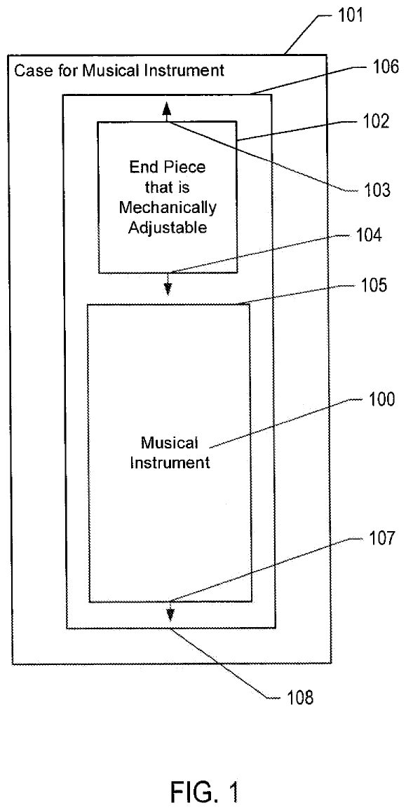

FIG. 1 is a flow diagram showing a system for securing a musical instrument 100 inside a musical instrument case 101, comprising an end piece 102 that is mechanically adjustable to change external physical dimensions (shown as 103 and 1041. The system allows the user to mechanically adjust the end piece 102 so that it mates with the musical instrument body end 105 and creates a friction hold and/or a mechanical hold against the interior case wall 106 and presses the musical instrument 100 against the opposite wall 108, thereby securely holding the musical instrument inside the instrument case 101. The expansion forces 103 and 104 created by the mechanically adjustable system presses and holds the musical instrument with force 107 safely against the interior case wall 108 while force 103 presses and holds against case wall 106.

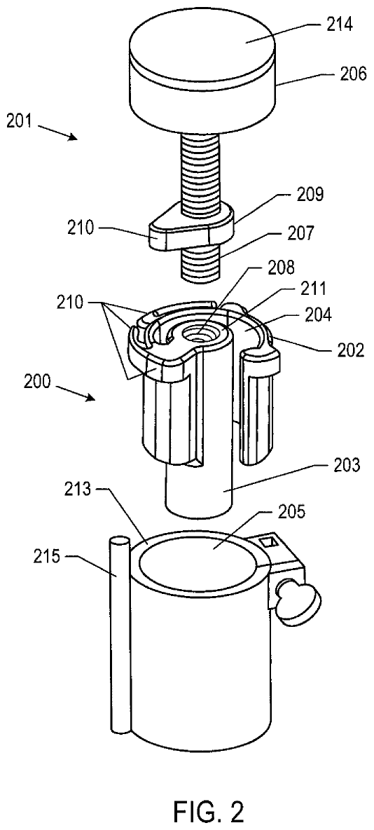

FIG. 2 shows an exploded view of an example support system for securely holding a musical instrument (a saxophone in this example) inside an instrument case. This example support system includes an end piece 200 with a mated screw 201. The end piece 200 includes a flat spring 202 attached at a mounting point shown in this example as a cylindrical shaft 203. The flat spring 202 has a radial curved arc and is mounted along the tubular surface of the cylindrical shaft 203 and partially wraps around the tubular surface of the cylindrical shaft 203 with a gap 204 separating the inner surface of the flat spring 202 from the outer tubular surface of the cylindrical shaft 203.

The end piece 200 interacts with the musical instrument when a musician compresses the flat spring 202 and inserts the end piece 200 into the body end neck socket 205 (shown here as a cut section view). The compressed radius curve of the flat spring 202 then expands to distribute force out toward the tubular wall of the body end neck socket 205. The flat spring 202 exerts force perpendicular to the axis of the musical instrument body tube 205 thus creating a distributed friction mount hold of the end piece 200 with the body tube end 205. This system adapts instantly to fit a wide variety of body tube diameters.

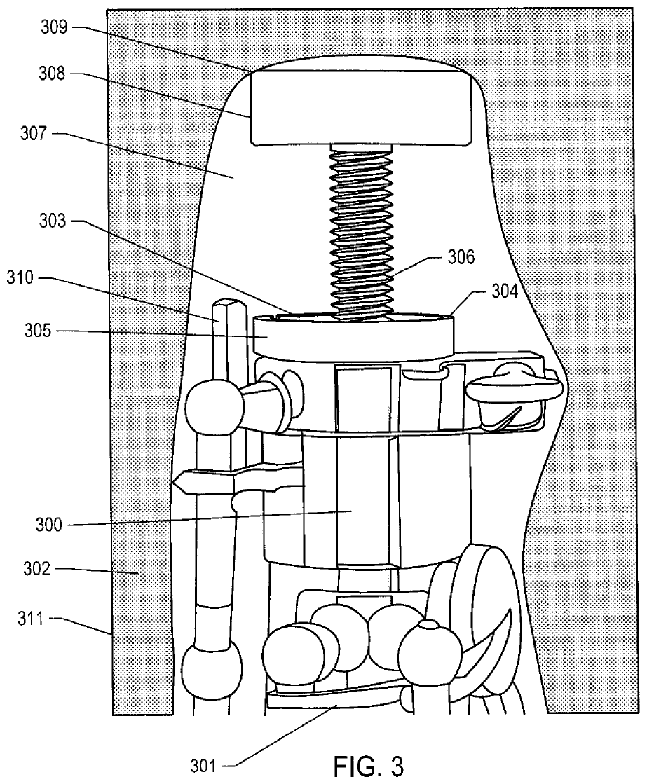

The screw 201 includes a head 206 and may be knurled or textured. The screw 201 also has a threaded shaft 207 with a diameter and threading that securely mates with the internally threaded cylindrical opening 208 that runs parallel to the tubular shape of the cylindrical shaft mounting point 203. The mechanical adjustability of this system allows the user to rotate the screw 201 to change the external physical dimensions of the device to fill a loose-fitting case thus increasing the mechanical hold forces that secure the musical instrument in relation to the instrument case interior as shown in FIGS. 1 and 3.

FIG. 2 shows the screw 201 operating along a specific and singular axis direction yet this system can be configured to operate along any axis or even expanded to include multiple screws operating in multiple axes.

A threaded locknut 209 is mated with the threaded shaft 207 of the screw 201. The locknut 209 includes a protrusion 210 so the user can rotate and adjust the locknut 209 by hand to tighten the locknut 209 against the mounting point edge 211 to create a friction hold of the threaded screw shaft 207 at a specific rotation and extension length distance setting. In other embodiments, the locknut 209 may be a wing nut, hex nut, knurled nut, or simply a tight-fitting elastomer washer that places a friction hold on the screw threads 207 to limit screw 201 rotating away from the height setting desired by the user.

The end piece 200 includes protruding brace features 212 that extend beyond the outer surface of the flat spring 202 and are located along a curved edge of the flat spring 202. When the end piece 200 is inserted into the body tube neck socket 205 the brace features 212 contact the body end edge 213 to provide positive stopping action of the end piece insertion forces. This brace feature creates a mechanical hold with the musical instrument that is critical to stop the end piece 200 from falling into the instrument and causing, damage, and also to provide mechanical opposition to the insertion force created by the screw 201 extending from the end piece 200 to press against the instrument case interior wall.

In this example, the flat spring 202 is configured as a curved partial coil torsion spring to provide shock absorption. Impact forces from a musical instrument case drop, shake, or hit is reduced via the flex and torsion of the flat spring 202 before the damaging forces can reach the instrument. For example, when the musical instrument case receives an impact the shock force travels through the case to the rigid screw 201 and then to the mounting point 203 suspended flexibly inside the torsion spring 202 where the impact shock force is decreased by the flexing spring 202 before the shock force reaches the musical instrument body. A traditional end piece made of rigid material lacks this shock absorption protection against impact, torque or torsion forces.

The shock absorbing benefit of this system can be further enhanced by adding elastomer materials or shock absorbers to the contact surfaces that interact with the musical instrument and musical instrument case. For example, 214 shows a rubber elastomer attached to the screw head 206. In an alternative embodiment the elastomer could be replaced with a spring. The end piece surfaces that touch with the musical instrument 202 and 212 can also include elastomer, elastomeric, visco-elastic, foam, or other compressible materials such as rubber to increase shock absorption properties and provide increased mechanical grip hold.

Because this system holds the musical instrument in a secure and shock dampened position inside the case, the octave key arm 215 has optimal protection and there is no need for brute force bracing of the octave key as is common with traditional end pieces.

This system provides a secure fitting end piece, a stationary and safe hold of the instrument inside the case, key mechanism protection, shock absorption from impact and torsion forces, and mechanical adjustability to serve a wide variety of musical instrument models and case model designs.

Another benefit of this system is increased air ventilation via the gap 204 that allows air flow in and through the body tube 205 during storage to help air dry the musical instrument after play. Most traditional end pieces trap moist air inside the musical instrument to rot.

Height, width, length or depth of this system can be made to suit the various size, shape or volume needs of a given instrument. This mechanically adjustable system is easy for a musician to quickly compress, flex, expand, or adjust to safely support the musical instrument inside the case.

The end piece 200 may be made from plastic, wood, or metal or other flexible materials. For example, the end piece 200 made from a thermoplastic polymer that allows the spring 202 to flex and retain spring tension. This system may include one or more shock absorber such as a torsion spring, flat spring, helical compression spring, elastomer spring, volute spring, or other spring mechanism to reduce impact shock to the instrument.

With this system, the instrument is held in a safe and neutral position inside the case so the instrument cannot wobble, bounce or move in a harmful way.

FIG. 3 shows a section view close up of the example support system inserted in a body tube end neck socket 300 of a musical instrument 301 surrounded by case padding 302 of an musical instrument case 311. The end piece 303 including flat spring 304 is inserted inside the body tube end neck socket 300 with the brace features 305 resting against the edge of the body tube end neck socket 300. A user compresses the flat spring 304 to insert the end piece into the body tube end neck socket 300. Once inserted, the flat spring 304 expands outward against the inner wall of the body neck socket 300 creating a secure friction mount hold of the end piece 303 with the musical instrument 301. The screw 306 is mechanically adjustable by the user to change external physical dimensions of the device and fill loose space of the instrument case interior 307. As shown in this example, the screw head 308 presses up against the case \sail 309 causing the end piece 303 to press down toward the musical instrument 301 increasing both the mechanical hold and friction hold of the end piece 303 with the body tube end 300. The flexibility of the flat spring 304 serves as a shock absorber to reduce damage from rough handling or impact to the musical instrument case. The brace feature 305 provides mechanical stop for the force a musician uses to insert the end piece 303 and the brace feature 305 helps transfer the forces created when screw 306 is extended. This presses the musical instrument so it is held against the opposing interior wall of the case (as shown in FIG. 1, 107, 108) which is implied but not shown FIG. 3 because it is a section view. The brace feature 305 in this example also serves as redundant support for octave key arm 310. All of this works together to stabilize and secure the musical instrument in the loose-fitting interior void 307 of the musical instrument case 311.

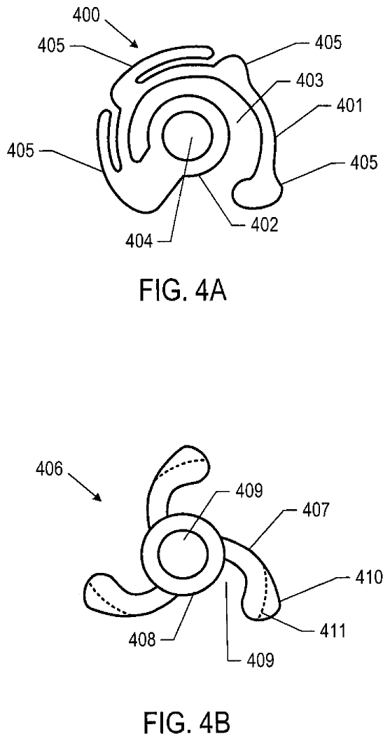

FIG. 4A shows a top view of the end piece shown previously in FIGS. 2 and 3. The end piece 400 having a spring 401 connected to mounting point 402 and a gap 403 between the mounting point 402 and spring 401. The mounting point 402 having a threaded interior shaft 404 where the screw shown in FIG. 2, 201 can mate. Multiple brace features 405 extend from the spring 401.

FIG. 4B shows a top view of another embodiment of an end piece having three springs exerting force perpendicular to the axis of the musical instrument body tube. The end piece 406 includes three symmetrically repeating springs 407. For clarity of graphic illustration we have numbered only one of the three springs. The springs 407 connect to a mounting point 408 creating a gap 409 between the mounting point 408 and springs 407. The mounting point 408 includes a threaded interior shat 409 where a screw can mate to create the mechanically adjustable features shown in FIG. 2 and FIG. 3. Brace features 410 extend from the spring 407. Because this is a top view illustration, a dotted line 411 has been added to show where the spring wall 407 ends and the protrusion of the brace features 411 begins. The springs 407 are not limited to radially curved springs. In alternatively implementation, straight cantilever springs may be attached to the mounting point 408, allowing a user to flexibly compress the springs and insert as needed.

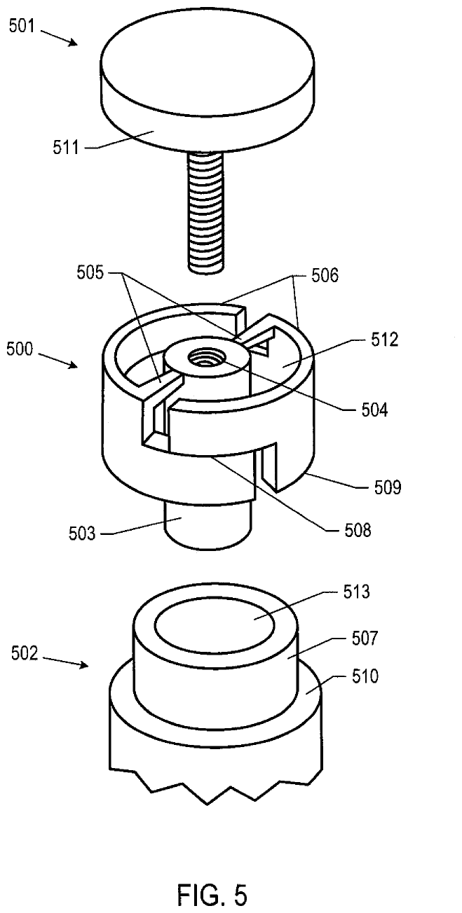

FIG. 5 is an exploded view of an example support system for securely holding an oboe inside a case. The system includes an end piece 500 and screw 501 that work together to engage the oboe tenon body end 502 (shown here as a cut away section view). The end piece includes a mounting point 503 with central threaded shaft 504 to receive the screw 501. The mounting point 503 includes two bracing features 505 that connect two flat springs 506 having curves and flexibility sufficient to contract around the tenon body end 507 and maintain a friction mount hold with the musical instrument. Because the springs 506 exert force perpendicular to the axis of the body end 502 a more evenly distributed hold is made with the body tube. The two flat springs 506 half lap each other (shown as 508 and visually implied behind the mounting point 503 and threaded shaft 504). When the end piece 500 is mounted with the instrument 502 the bottom of the flat springs 509 are pressed against the body wall 510 and serve as brace feature to resist insertion forces. The brace features 505 and 509 also help position the device in a secure mechanical hold of with the musical instrument.

The screw 501 includes a large head 511 that is easily rotated by the user to change the external physical dimensions of the whole device inside the instrument case, so the system is able to engage both the musical instrument and case in a secure friction hold and mechanical hold. As with FIGS. 2, 3 and 4 this example also includes an air gap 512 for air flow through the body tube interior 513 and the flexing of the springs 506.

A mechanically adjustable end piece may be formed from many combinations of a spring, screw, or compressible material in combination with either walls or end pieces to match the general shape of the musical instrument. The end pieces can be made of a wide variety of materials including, but not limited to, a polymer, metal, rubber, wood, foam, etc and be made mechanically adjustable by one or more of a compression spring, expansion spring, flat spring, spiral spring, coil spring, torsion spring, strip spring, linear wave spring, disc spring, shock absorber, screw, elastomer, pressure plates, flexible arms, expanding collet, telescope, attachable sections, etc. The advantage of this system is the many affordable ways one can create adjustable musical instrument storage with impact resistant design.

It is appreciated that the previous description of the disclosed embodiments is provided to enable any person skilled in the art to make or use the present disclosure. Various modifications to these embodiments will be apparent to those skilled in the art, and the generic principles defined herein may be applied to other embodiments without departing from the spirit or scope of the disclosure. Thus, the present disclosure is not intended to be limited to the embodiments shown herein hut is to be accorded the widest scope consistent with the principles and novel features disclosed herein.

1. A system for securing a musical instrument inside a musical instrument case, the system comprising a mechanically adjustable end piece that when located between an interior surface of the musical instrument case and the musical instrument thereby holding the musical instrument inside the case.

2. The system of claim 1 wherein the end piece includes a spring that helps create the hold of the musical instrument inside the case.

3. The system of claim 1 wherein the end piece includes one or more of a flat spring, a torsion spring, a volute spring, a helical compression spring, a cantilever, and an elastomer spring.

4. The system of claim 1 wherein the end piece includes a radial curved flat spring that holds against either the interior or exterior of the musical instrument body tube end.

5. The system of claim 1 wherein the system includes a screw that mates with the end piece and is mechanically adjustable to create a friction and mechanical hold of the musical instrument inside the case.

6. The system of claim 5 further comprising one or more of a locknut and a tight-fitting elastomer washer to stop rotation of the screw when mated with the end piece.

7. The system of claim 5 wherein the screw includes a shock absorber.

8. The system of claim 1 wherein the end piece includes a shock absorber.

9. A system for securing a musical instrument within an instrument case, the system comprising an end piece having a radial curved flat spring that when engaged with a body tube end of the musical instrument exerts a force perpendicular to the central axis of the musical instrument body tube, thereby attaching the end piece to the musical instrument.

10. The system of claim 9 wherein the radial curved flat spring is coiled.

11. The system of claim 9 wherein the end piece includes a brace feature that limits end piece insertion against a musical instrument body end.

12. A system for securing a musical instrument within an instrument case, the system comprising:
an end piece having a mounting point and a spring; and
a screw that mates with the mounting point.

13. The system of claim 12 wherein the spring includes a flat spring curved greater than 180 degree arc.

14. The system of claim 12 wherein the mounting point is a threaded shaft to receive the screw.

15. The system of claim 12 further comprises a locknut that attaches to the screw.

16. The system of claim 12 wherein the screw includes a thumb screw top.
